(19) United States
(12) Patent Application Publication
(10) Pub. No.: US 2011/0246247 A1
(43) Pub. Date: Oct. 6, 2011

(54) Restaurant inventory management

(75) Inventors: Charles Norman McCullough, Oakland, CA (US); Paul Higgins, Oakland, CA (US)

(73) Assignee: OpenTable, Inc.

(21) Appl. No.: 12/798,316

(22) Filed: Mar. 31, 2010

(51) Int. Cl. G06Q 50/00; G06Q 10/00; G06F 3/01

(52) U.S. Cl. 705/5; 715/760

(57) ABSTRACT

A system for inventory management comprises a processor and a memory. The processor is configured to receive restaurant reservation information. The processor is further configured to determine a first list of combinations and permutations of possible reservations available for one or more time periods based at least in part on the restaurant table configuration information. The processor is further configured to determine a second list of combinations and permutations of possible reservations available for the one or more time periods, wherein the second list removes combinations and permutations that are not available due to a selection of a reservation from the list. The memory is coupled to the processor and configured to provide the processor with instructions.

### BACKGROUND OF THE INVENTION

A common approach to managing restaurant inventory uses fixed slots of time for fixed table configurations of a restaurant floor. However, diners and restaurant managers do not always arrange their meal times and/or their tables in the fixed time slots and/or table configurations. When the meal times and/or table configuration do not align with the time slots and/or table configurations, this can result in underutilization or overbooking of the restaurant.

### BRIEF DESCRIPTION OF THE DRAWINGS

Various embodiments of the invention are disclosed in the following detailed description and the accompanying drawings.

FIG. 1 is a block diagram illustrating an embodiment of a system for restaurant inventory management.

FIG. 2 is a block diagram illustrating an embodiment of a service provider system.

FIG. 3 is a flow diagram illustrating an embodiment of a process for managing restaurant inventory.

FIG. 4 is a block diagram illustrating an embodiment of a display for configuration information.

FIG. 5 is a block diagram illustrating an embodiment of a display for a grid view.

FIG. 6 is a block diagram illustrating an embodiment of a display for a floor layout.

FIG. 7 is a block diagram illustrating an embodiment of a display for a sheet view.

FIG. 8 is a block diagram illustrating an embodiment of a display for a table combination view.

FIG. 9 is a block diagram illustrating an embodiment of a display for a table combination editing.

FIG. 10 is a block diagram illustrating an embodiment of a display for sheet editing.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for restaurant inventory management is disclosed. The system comprises a processor and a memory. The processor is configured to receive restaurant table configuration. A first list of combinations and permutation of possible reservations available for one or more time periods is determined based at least in part on the restaurant table configuration information. A second list of combinations and permutation of possible reservations available for one or more time periods is determined. The second list removes combinations and permutation that are not available due to a selection of a reservation from the list; the second list comprises the reservation availability. The memory is coupled to the processor and configured to provide the processor with instructions. In some embodiments, the system narrows the first list dynamically as reservations are made/inventory is committed to generate the second narrowed list.

In some embodiments, the system comprises a user interface (e.g., a human-machine interface—for example, a graphical user interface). In some embodiments, the system is connected to the Opentable network (e.g., a network comprising a plurality of restaurant systems, a web available system, and a main server system). In some embodiments, the processor is configured to receive operational information (e.g., server information, shift start and stop information, chef information, personnel information, menu information, special occasion information, etc.). In some embodiments, the processor is further configured to present restaurant reservation availability to the external (Opentable) network. In some embodiments, the processor is further configured to receive restaurant reservation requests, choose the most suitable assignment of the request to a resource and transmit the assignment back to the network; or deny the request if there are not sufficient resources.

In some embodiments, the restaurant availability is provided to a restaurant and/or to the web and thereby to a customer or diner. In various embodiments, restaurant availability is provided in such a manner as to provide no table combinations, all table combinations, pacing by covers, pacing by party, pacing by covers/party and by server or section, pacing for large parties separate from small parties, or any other appropriate manner. In various embodiments, restaurant combinations are all auto generated, partially auto generated (e.g., by spatial areas, by party size cap or limit, by a cap or limit on the number of tables in a combination, etc.), manually, manually with overrides to auto methods, or any other appropriate manner or combination of manners. In various embodiments, turn times are determined manually, automatically (e.g., based on historic turn times based on different factors including weather, holidays, shifts, days of the week, time of the day, etc.), or any other appropriate factor.

In various embodiments, restaurant configuration information comprises a table configuration including a maximum seating size, a minimum seating size, a list of tables that can be combined, a blocked table list, a single seating list, a fixed time seating list, a very important person (VIP) seating list, seating order preference, special attributes such as smoking section, or any other appropriate configuration information. In various embodiments, a table on the block table list (including blocking the table for combinations) blocks a table for a specific time period such that the table will be held available for that time period (no other reservation can coincide with the time period)—the time period can be zero, in which case the table is guaranteed to turn at that time; a table on the block table list (including blocking a table for combinations) blocks a table such that no reservations can be made within a given time period (no seating for the table during the period); a table on the block table list (including blocking a table for combinations) blocks a table such that reservations can only be seated within a time period (force seating for the table during fixed periods, or any other appropriate functionality for a block table list.

In some embodiments, the selection of the reservation is received (e.g., from a maitre d′ selecting a specific date, time, and/or party size). In some embodiments, the selection of the reservation (e.g., the specific table or set of tables at the restaurant) is based on a rule enabling automatic selection. In various embodiments, the rule for selecting a reservation comprises maximizing revenue, maximizing customer satisfaction, maximizing table availability, minimizing wait time, balancing load to wait staff, utilizing tables in a specific order (e.g., near windows first, back of the restaurant last, balancing among sections, etc.), or any other appropriate rule. In various embodiments, the selection of the reservation is determined based at least in part on one or more of the following: the time length of the reservation (e.g. turn time), the party size of the reservation in relation to other committed reservations (pacing) historical restaurant reservation information (e.g., used in the prediction of customer arrivals or customer flow), a historical customer search information (e.g., used in the prediction of customer demand and potential flow for tables in the restaurant), a maximum arrival rate for customers at a restaurant, a maximum arrival rate of parties at the restaurant, minimizing the number of combined table reservations by always offering uncombined tables first, or any other appropriate information to aid selection of a reservation. In some embodiments, the turn time is received (e.g. from the maitre d′). In some embodiments, the turn time is calculated from historical turn time from past reservations in the memory, (e.g., prediction of a table availability) based on factors such as party size, time of day, date, holiday configuration, or weather. In some embodiments, the turn time is calculated based on a configuration dependant on time of day, and particular date or day of week a configured maximum arrival rate as measured in individuals or parties or categories of parties that can be supported by the restaurant depending on the time, date and day of the week. In some embodiments, reservation size in relation to other committed reservations can be used to limit the number of reservations committed during a time interval (e.g., pacing) to maximum customer flow while still providing acceptable service. In various embodiments, the pacing is calculated by counting the total number of covers arriving for a time segment (pacing) or for the entire shift (e.g., allotment model), the number of parties for a time segment or a shift, or for categories of parties based on size (e.g., large party pacing). In various embodiments, the reservation is determined by suitability factors (e.g., minimum or maximum party size to seat at a table), the best fit (e.g., closest table size), historical resource utilization (e.g., table often combined in past seatings), optimization parameters assigned to the configuration, or any other appropriate factor. In some embodiments, rules determine the inventory offered to diners—for example, the restaurant initially offer all possible party sizes for a particular date and time (given the capacity of the restaurant) and then reduces this as reservations are booked, until the maximum arrival rate is reached; once the maximum arrival rate is reached it would not offer any inventory for that date and time.

In some embodiments, improvement to restaurant table utilization is achieved by determining all possible combination and permutation of available seating for the restaurant. All the possible combinations and permutations are offered to a potential customer. Upon selection of a reservation, the combinations and permutations available for reservations are updated to remove all conflicting combinations and permutations of reservations. In various embodiments, flexibility regarding the time configurations for table availability and flexibility (e.g., any possible start time for a meal, 15 minute increment start times, 1 start time per day, 3 seatings per evening, etc.), flexibility regarding table configurations (e.g., pushing tables together, adding tables to the floor, rearranging tables on the floor, etc.), or any other appropriate flexibility. In some embodiments, the combinations are received in the reservation (e.g., by a maitre d′). In some embodiments, the combinations are calculated using pre-defined table combination configuration data. In various embodiments, the combinations re calculated using defined relationships of the tables (e.g., spatial relationships) or limited based on other defined propertied (e.g. maximum number of tables to be combined), or in any other appropriate manner.

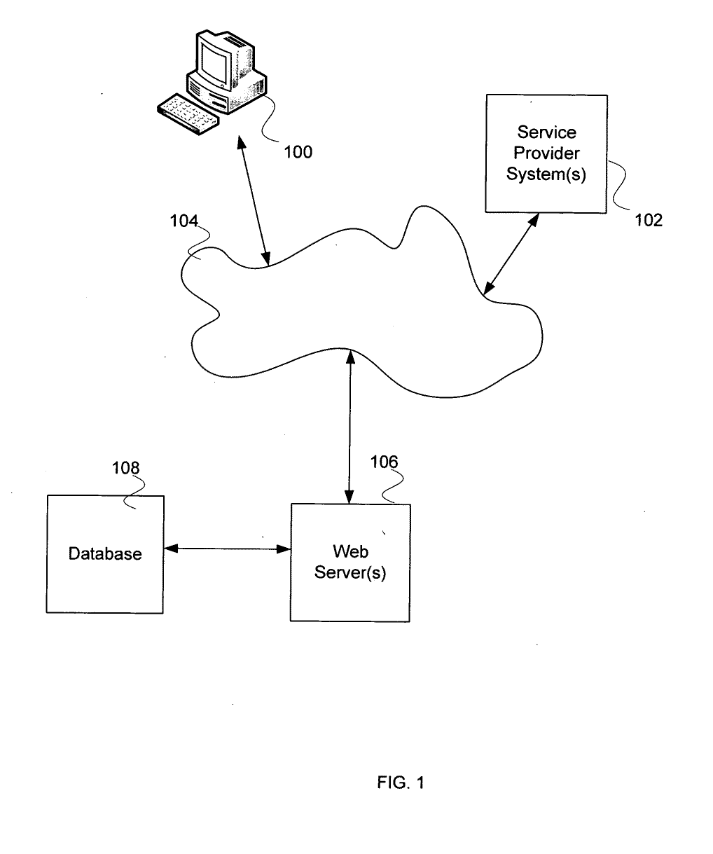

FIG. 1 is a block diagram illustrating an embodiment of a system for restaurant inventory management. In the example shown, user 100 communicates via network 104 with web server(s) 106. User 100 requests availability of a restaurant reservation. Web server(s) 106 provide information regarding available restaurant reservation (e.g., search results, reviews, time availability, menus, seating chart, table layouts, special services, etc.). Web server(s) 106 communicate directly or via network 104 with service provider system(s) 102. Web server(s) 106 communicate reservation availability information, reservation confirmation information, menu information, seating chart and/or table layout information, etc. with service provider system(s) 102 (e.g., restaurant(s)). Web server(s) 106 communicate with database 108. Database 108 stores service provider information (e.g., reservations, menus, table configurations, customer profiles, etc.). In various embodiments, a network coupled to the processor to a publicly accessible web site via the Internet provides functionality of one or more of the following: functionality to transmit availability of reservations, functionality to transmit requests from the web site, functionality to transmit returned reservation acceptance information, or any other appropriate functionality. In various embodiments, a graphical user interface associated with web server(s) 106 or service provider system(s) 102 is coupled to the processor for one or more of the following: to receive and return reservation requests, to provide reservation availability, to provide reservation confirmation information, and/or for any other appropriate functionality.

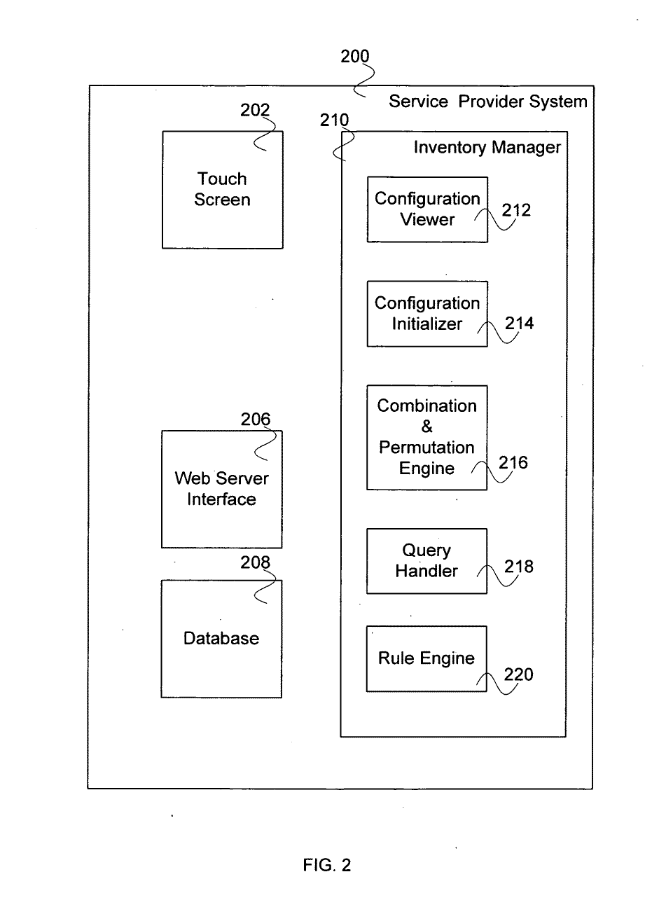

FIG. 2 is a block diagram illustrating an embodiment of a service provider system. In some embodiments, service provider system 200 of FIG. 2 is used to implement one system of service provider system(s) 102 of FIG. 1. In the example shown, service provider system 200 comprises touch screen 202, web server interface 206, database 208, and inventory manager 210. Touch screen 202 is used to interface to service provider system 200. For example, a restaurant manager interfaces with service provider system 200 using touch screen 202 to navigate, enter commands and parameters, or any other appropriate interaction with the service provider system. Web server interface 206 interfaces system provider system 200 and a web server. Web server interface 206 is used to communicate reservation information, confirmation information, configuration information, menu information, or any other appropriate information. Database 208 stores service provider information. Service provider information includes reservation information, confirmation information, menu information, configuration information, etc.

Inventory manager 210 comprises configuration viewer 212, configuration initialize 214, combination & permutation engine 206, query handler 218, and rule engine 220. Inventory manager 210 enables more efficient use of restaurant inventory by offering availability of all possible combinations and/or permutations of restaurant reservations. Then upon receipt of a new reservation, the list of possible combination and/or permutations is updated to remove combinations and/or permutations that are eliminated by the new reservation. For example, combinations and/or permutations that is/are not possible because the new reservation conflicts with them, i.e., use the same table within the same time period or likely time period based on historical average time used for the reservation, historical user time used, etc. Configuration viewer 212 enables a service provider employee to view the restaurant configuration. The configuration information includes table configuration for restaurant (e.g., location of table, combination possibilities, number of seats, etc.). Configuration initializer 214 is used to initialize the configuration for the restaurant. Combination & permutation engine 216 is used to determine the possible combinations and/or permutations of reservations available for a restaurant given the configuration of the restaurant and the existing reservations. Query handler 218 is used to handle queries regarding inventory. For example, a query is made regarding the available reservations that include all possible permutations and combinations of available times and available table configurations for a given restaurant. Rule engine 220 is used to determine a selection of a reservation/table/time slot based on a rule. Rule engine 220 is able to automatically select a reservation for a table/time slot.

In some embodiments, the selection of the reservation (e.g., the specific table at the restaurant) is based on a rule enabling automatic selection. In various embodiments, the rule for selecting a reservation comprises maximizing table availability (e.g., a best fit followed by a selection of maximizing table availability), minimizing wait time, balancing load to wait staff, utilizing tables in a specific order (e.g., near windows first, back of the restaurant last, or any other appropriate rule. In various embodiments, the selection of the reservation is determined based at least in part on one or more of the following: maximizing revenue (e.g., maximizing revenue can cause more/longer wait times), maximizing customer satisfaction (e.g., maximizing customer satisfaction can underutilize the restaurant), a historical turn time (e.g., used in the prediction of a table availability), a received turn time (e.g., from a maitre d′) a historical restaurant reservation information (e.g., used in the prediction of customer arrivals or customer flow), a historical customer search information (e.g., used in the prediction of customer demand and potential flow for tables in the restaurant; where historical can mean that the rule is based on the previous day, the same day of the previous week, month, or year, or any other meaningful earlier period such as a holiday period), a maximum arrival rate for customers at a restaurant (e.g., where the maximum arrival rate is based on an individual arrival rate, a party arrival rate, a large party arrival rate, etc. and a time segment for example 15 minute interval or entire shift length), or any other appropriate information to aid selection of a reservation.

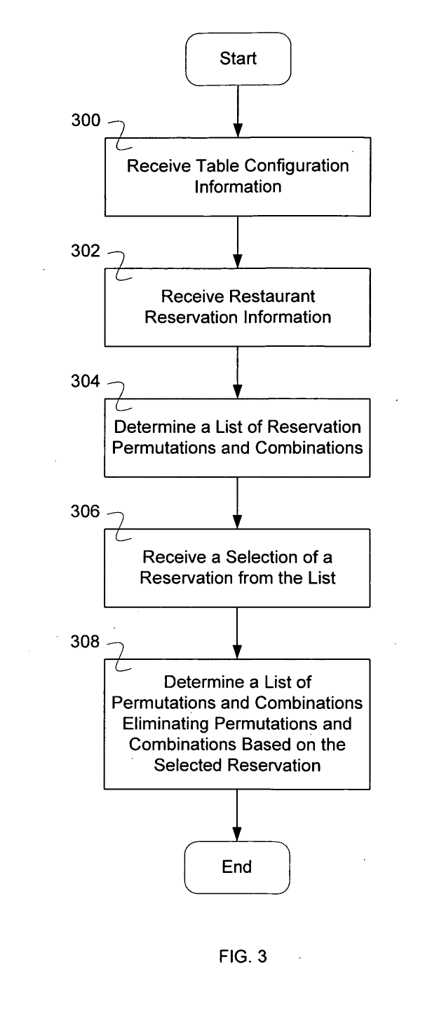

FIG. 3 is a flow diagram illustrating an embodiment of a process for managing restaurant inventory. In the example shown, in 300 table configuration information is received. For example, table configuration information number of tables, minimum and maximum party size to be seated on each table, commonly combined tables, the party sizes to be seated at combinations, the maximum number of covers allowed to arrive at any time increment, and the expected turn time for each allowed party size is received as information that is input from a service provider employee (e.g., restaurant maitre d′). In 302, restaurant reservation information is received. In 304, a list of reservation permutation and combinations is determined. In 306, a selection of a reservation from the list is received. In 308, a list of permutations and combinations is determined eliminating permutations and combinations based on the selected reservation.

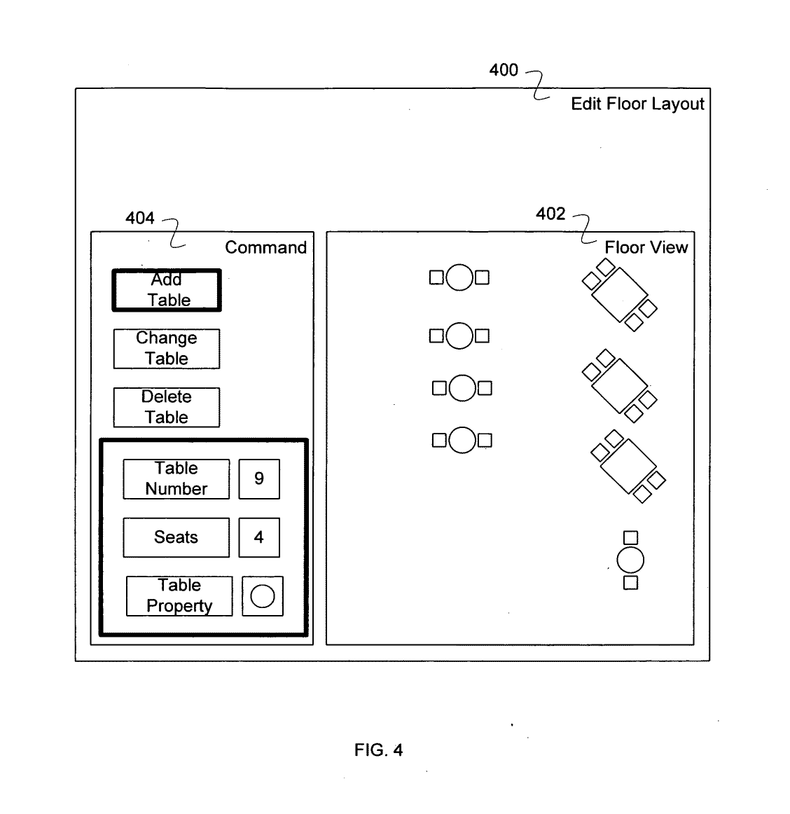

FIG. 4 is a block diagram illustrating an embodiment of a display for configuration information. In the example shown, edit floor layout 400 comprises a user display on a touch screen display. The user display includes floor view 402 and command 404. Floor view 404 displays a schematic view of a restaurant floor showing table positions as well as seating configurations of each table. Command 404 includes commands associated with editing the floor layout including add table, change table, and delete table. In the view shown, add table is selected as indicated by the heavier line around the add table button. The add table window box shows a table number added (e.g., ‘9’), the seats for the added table (e.g., ‘4’), and a table property (e.g., a round table as indicated using a circle).

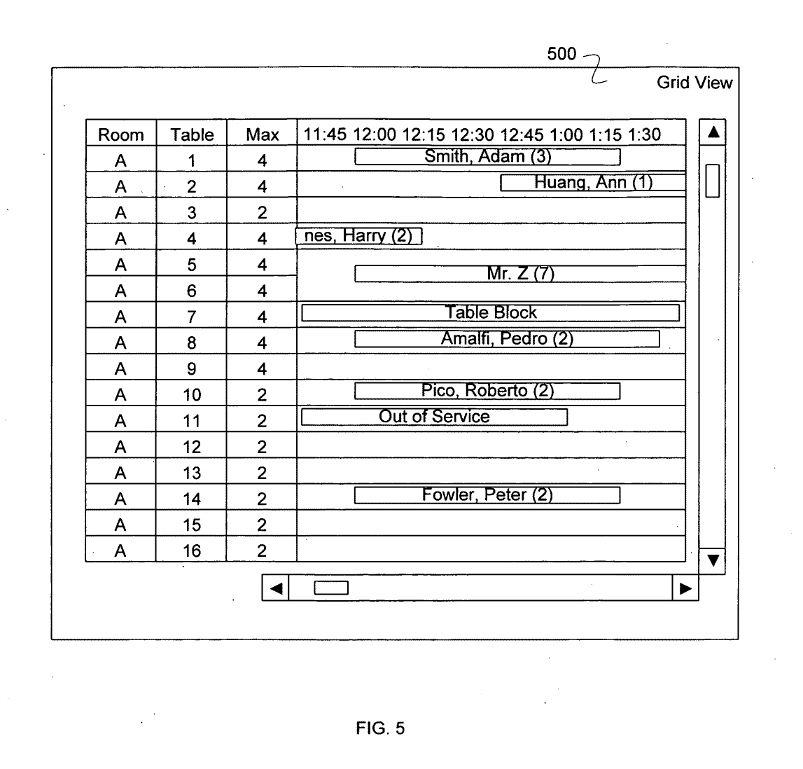

FIG. 5 is a block diagram illustrating an embodiment of a display for a grid view. In the example shown, grid view 500 includes columns for the restaurant dining room ('Room'), table number ('Table'), maximum seating ('Max'), and a bar chart showing time and reservations. The column for room shows a room designated ‘A’ for all rows visible in the display of grid view 500. The column for table shows a table number designated from ‘1’ up to ‘16’ for the rows visible in the display of grid view 500. The column field for ‘Max’ shows the value ‘4’ for rows corresponding to table numbers ‘1’ to ‘9’ and the value ‘2’ for rows corresponding to ‘10’ to ‘16’. In the row corresponding to the table labeled ‘1’, there is a bar showing a reservation for Smith, Adam (3)—a party of three from 12:00 to 1:15. In the row corresponding to the table labeled ‘2’, there is a bar showing a reservation for Huang, Ann (1)—a party of one from 12:45 to after 1:30. In the row corresponding to the table labeled ‘4’, there is a bar showing a reservation for Jones, Harry (2)—a party of two from before 11:45 to 12:00. In the rows corresponding to the table labeled ‘5’ and ‘6’, there is a bar showing a reservation for Mr. Z (7)—a party of seven from 12:00 to after 1:30. In the row corresponding to the table labeled ‘7’, there is a bar showing a table block—no one is allowed to be seated for the entire period shown (e.g., 11:45 to 1:30). In the row corresponding to the table labeled ‘8’, there is a bar showing a reservation for Amalfi, Pedro (2)—a party of two from 12:00 to 1:30. In the row corresponding to the table labeled ‘10’, there is a bar showing a reservation for Pico, Roberto (2)—a party of two from before 12:00 to 1:15. In the row corresponding to the table labeled ‘11’, there is a bar showing a table is out of service—a table is out of service from before 11:45 to after 1:00: In the row corresponding to the table labeled ‘14’, there is a bar showing a reservation for Fowler, Peter (2)—a party of two from before 12:00 to after 1:15.

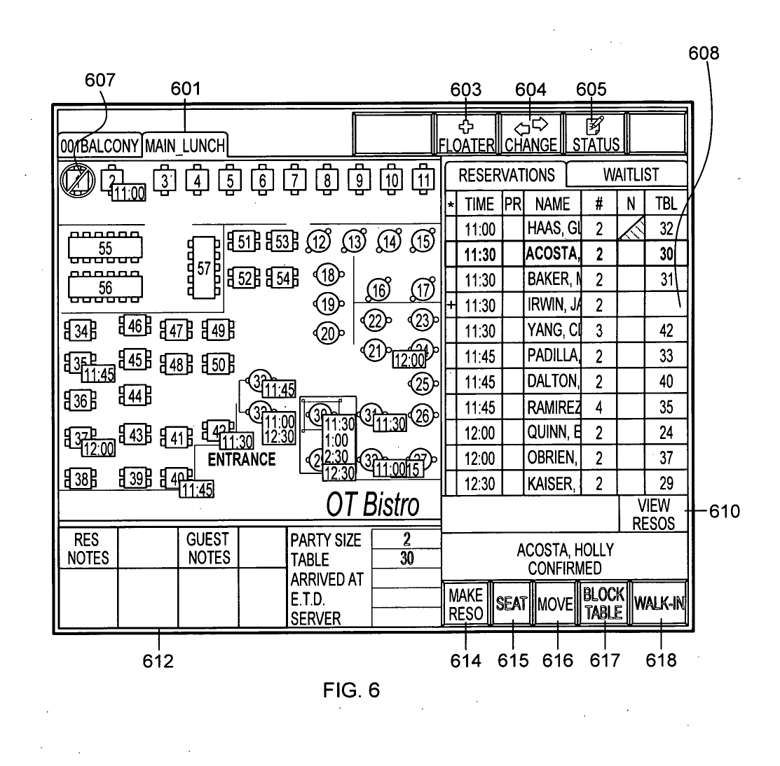

FIG. 6 is a block diagram illustrating an embodiment of a display for a floor layout. In the example shown, floor layout tab 601 selects a floor layout (e.g., a main lunch room) to display. In some embodiments, the floor layout enables a user to view all of the reservations assigned to a table, seat a party, mark a party as done, free the table back into inventory, move a party, and adjust the inventory, etc. Floater button 603 enables a user to insert a floater reservation or to enter a reservation to be assigned a specific table at a later time (e.g., at the beginning or the shift, when the party arrives, or when another party cancels). Change button 604 enables a user to make changes to a reservation. Status button 605 enables a user to change a status of a party. Blocked icon 607 indicates a blocked table on the floor layout display.

Floater row 608 is designated with a ‘+’ sign and is not assigned a table number (e.g., the 11:30 row with a reservation for Irwin, James for 2). Resos View button 610 enables a user to view reservation times on a given table. Notes boxes 612 enable a user to edit/enter/view notes regarding reservations and/or guests. Make Resos button 614 enables a user to make a reservation. Seat button 615 enables a user to seat a party at their table (e.g., a table reserved for them, a table assigned to them, etc.). Move button 616 enables a user to move a reservation to another table, seating time, or date. Block table button 617 enables a user to block a table or unblock a table. Walk-in button 618 enables a user to add a walk-in party.

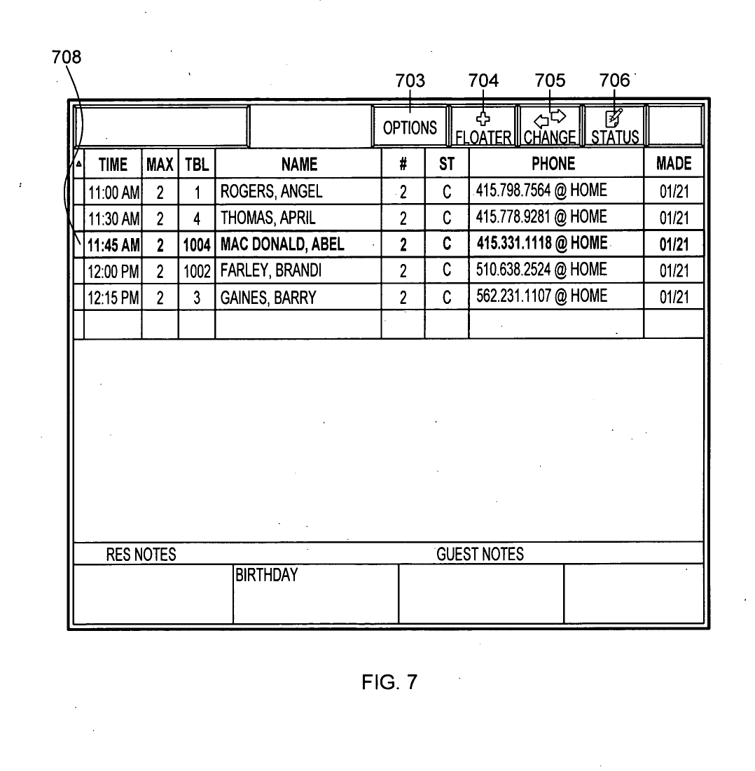

FIG. 7 is a block diagram illustrating an embodiment of a display for a sheet view. In the example shown, options button 703 enables a user to display a list of operations that can be performed using this sheet. Floater button 704 enables a user to insert a floater reservation. Change button 705 enables a user to list operations that can be changed for a selected reservation. Status 706 enables a user to change the status of a party. Reservation row 708 displays reservation information (e.g., time, maximum number of people, table number, reservation name, number of people in party, status, phone number, and a date when the reservation was made.

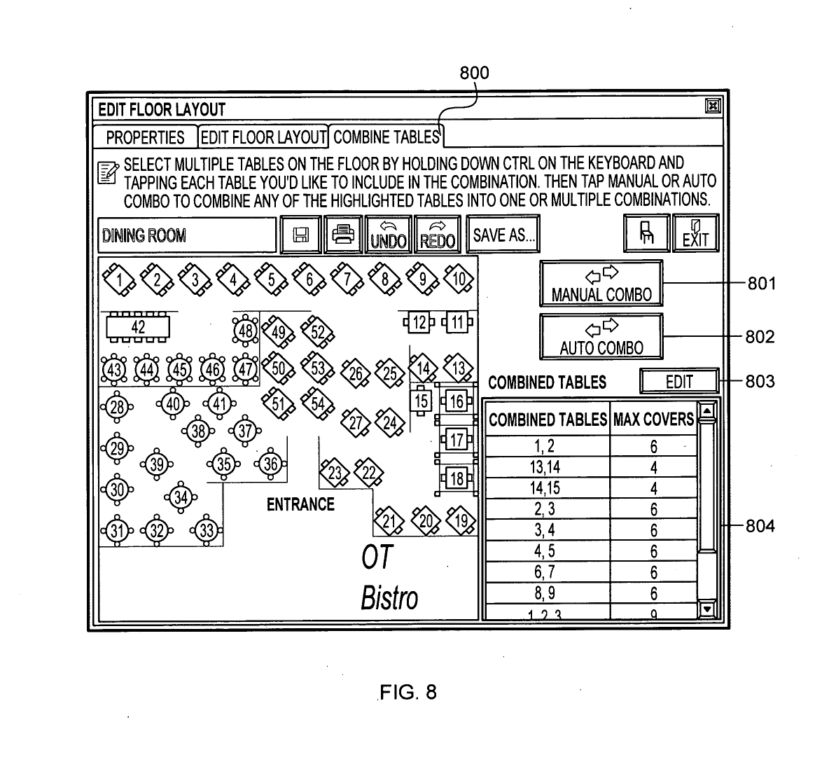

FIG. 8 is a block diagram illustrating an embodiment of a display for a table combination view. In the example shown, combine tables tab 800 displays a floor layout and enables a user to view, edit, and manually or automatically combine tables. Manual combo 801 enables a user to manually combine tables. Auto combo 802 enables a user to automatically generate combinations for tables (e.g., auto generated a combination risks for 3 or more tables). Edit button 803 enables a user to edit the combinations of tables for the floor layout shown. Display 804 shows the combinations of tables and the number of covers (e.g., the possible number of patrons that can sit at the combined tables).

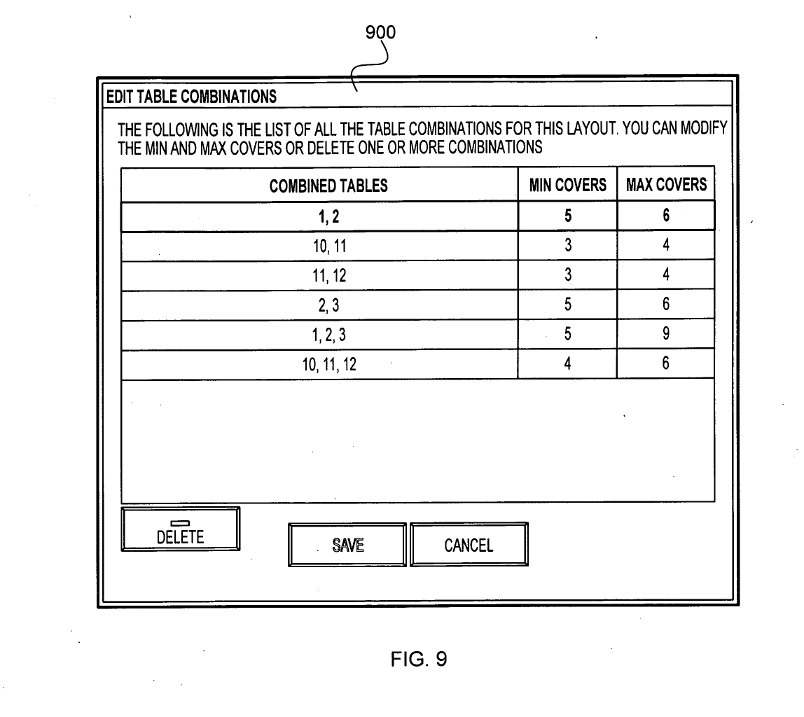

FIG. 9 is a block diagram illustrating an embodiment of a display for a table combination editing. In some embodiments, the display for a table combination editing of FIG. 9 is activated by edit button 803 of FIG. 8. In the example shown, edit table combinations display 900 includes a column displaying table combinations designated using table numbers, minimum covers for the combined tables, and maximum covers for the combined tables.

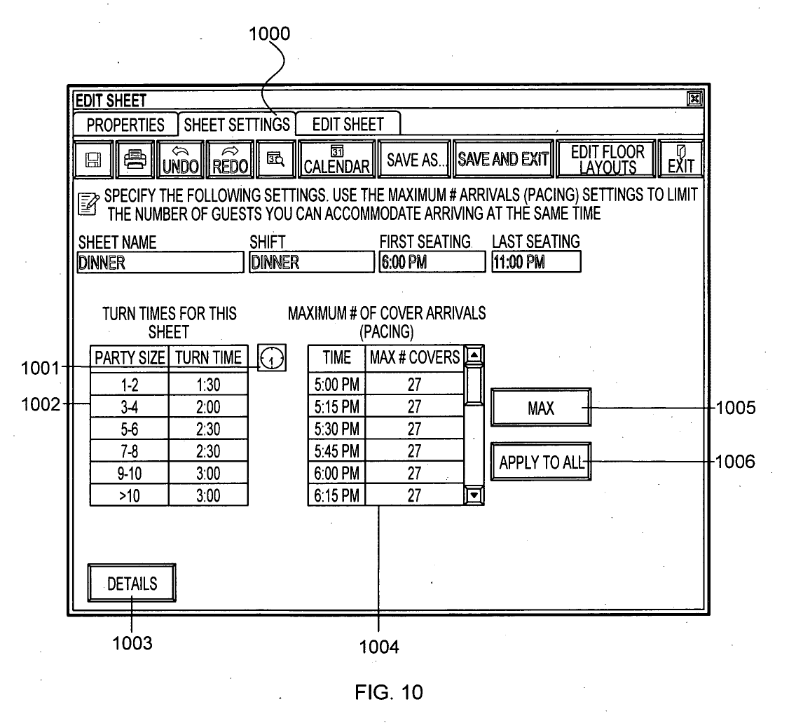

FIG. 10 is a block diagram illustrating an embodiment of a display for sheet editing. In the example shown, sheet setting tab 1000 enables a user to set sheet settings. Clock icon 1001 enables a user to edit turn time settings. Turn time table 1002 enables a user to view turn times for a given party size. Details button 1003 enables a user to view sheet capacity details. Maximum number of cover arrivals (pacing) 1004 enables a user to view the maximum number of cover arrivals in a given time period. Max button 1005 enables a user to assign a maximum number of covers for a specific time. Apply to all button 1006 enables a user to assign a maximum number of covers for all time periods.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for inventory management, comprising:
a processor configured to:
receive restaurant reservation information;
determine a first list of combinations and permutations of possible reservations available for one or more time periods based at least in part on the restaurant table configuration information;
determine a second list of combinations and permutations of possible reservations available for the one or more time periods, wherein the second list removes combinations and permutations that are not available due to a selection of a reservation from the list; and
a memory coupled to the processor and configured to provide the processor with instructions.

2. A system as in claim 1, wherein the first list of combination and permutations of possible reservations available for one or more time periods is based at least in part on a restaurant reservation information.

3. A system as in claim 1, further comprising a network coupled to the processor to a publicly accessible web site via the Internet providing functionality of one or more of the following: functionality to transmit availability of reservations, functionality to transmit requests from the web site, and functionality to transmit returned reservation acceptance information.

4. A system as in claim 1, further comprising a graphical user interface coupled to the processor for one or more of the following: to receive and return reservation requests, to provide reservation availability, and to provide reservation confirmation information.

5. A system as in claim 1, wherein the selection of the reservation from the list is received.

6. A system as in claim 1, wherein the selection of the reservation is determined based on a rule.

7. A system as in claim 3, wherein the rule is used to automatically determine the selection of the reservation along with a received customer desired reservation time and party size.

8. A system as in claim 4, wherein the rule comprises least in part on a best fit followed by maximizing table availability.

9. A system as in claim 4, wherein the rule comprises minimizing wait time.

10. A system as in claim 4, wherein the rule comprises balancing load to wait staff.

11. A system as in claim 4, wherein the rule comprises utilizing tables in a specific order.

12. A system as in claim 4, wherein the rule comprises maximizing revenue.

13. A system as in claim 4, wherein the rule comprises maximizing customer satisfaction.

14. A system as in claim 1, wherein the selection of the reservation is determined based at least in part on a historical turn time information.

15. A system as in claim 1, wherein the selection of the reservation is determined based at least in part on a received turn time information.

16. A system as in claim 1, wherein the selection of the reservation is determined based at least in part on a historical restaurant reservation information.

17. A system as in claim 1, wherein the selection of the reservation is determined based at is least in part on a historical customer search information.

18. A system as in claim 1, wherein the selection of the reservation is determined based at least in part on a maximum arrival rate.

19. A system as in claim 16, wherein the maximum arrival rate is based at least in part on one or more of the following: an individual arrival rate, a party arrival rate, a large party arrival rate, and a time segment.

20. A system as in claim 17, wherein the time segment comprises a 15 minute interval or an entire shift.

21. A system as in claim 1, wherein the restaurant table configuration information comprises a plurality of tables each with a seating size.

22. A system as in claim 1, wherein the restaurant table configuration information comprises a list of possible allowed combinations of combinable tables for the plurality of tables.

23. A system as in claim 1, wherein the restaurant table configuration information comprises a blocked table list.

24. A system as in claim 23, wherein a table on the blocked table list blocks the table for combinations.

25. A system as in claim 23, where a table on the blocked table list blocks the table for a specific time period such that the table will be held available for that time period.

26. A system as in claim 23, where a table on the blocked table list blocks the table such that no reservations can be made within a given time period.

27. A system as in claim 23, where a table on the blocked table list blocks a table such that reservations can only be seated within a time period.

28. A system as in claim 1, wherein the restaurant table configuration information comprises a single seating list.

29. A system as in claim 1, wherein the restaurant table configuration information comprises a fixed seating time list.

30. A system as in claim 1, wherein the restaurant table configuration information comprises a VIP seating list.

31. A method for inventory management, comprising:
receiving restaurant reservation information;
determining a first list of combinations and permutations of possible reservations available for one or more time periods based at least in part on the restaurant table configuration information; and
determining a second list of combinations and permutations of possible reservations available for the one or more time periods, wherein the second list removes combinations and permutations that are not available due to a selection of the reservation from the list.

32. A computer program product for inventory management, the computer program product being embodied in a computer readable storage medium and comprising computer instructions for:
receiving restaurant reservation information;
determining a first list of combinations and permutations of possible reservations available for one or more time periods based at least in part on the restaurant table configuration information; and
determining a second list of combinations and permutations of possible reservations available for the one or more time periods, wherein the second list removes combinations and permutations that are not available due to a selection of the reservation from the list.
